(19) United States
(12) Patent Application Publication
(10) Pub. No.: US 2016/0130375 A1
(43) Pub. Date: May 12, 2016

(54) POLYMER COAGULANTS

(71) Applicant: GENERAL ELECTRIC COMPANY, Schenectady, NY (US)

(72) Inventor: Kelly Scott CHICHAK, Clifton Park, NY (US)

(21) Appl. No.: 14/895,534

(22) PCT Filed: Jun. 3, 2013
(86) PCT No.: PCT/US2013/043840

§ 371 Date: Dec. 3, 2015

(51) Int. Cl. C08F 24/00; C02F 1/56

(52) U.S. Cl. CPC C08F 24/00; C02F 1/56

(57) ABSTRACT

Maleic anhydride polymers having pendant groups that contain at least one quaternary amine group are effective coagulants for use in treating wastewater and other waters containing dispersed impurities.

### BACKGROUND

Water, although simple in its chemical composition, is an essential component for sustaining life across a diverse array of organismal complexity whereby the key characteristic that defines the utility and value of this life sustaining commodity is its purity. And, in a continuous effort to meet the world's demand for clean water there has always been a need to improve methods that control its purity so that, for example, it may be recycled within industrial processes or used in potable consumer settings. As such, any particular process of water purification is unique to both its original composition and its final use, i.e., purifying an influent water source for an industrial process will be drastically different to a water effluent for an industrial discharge process. But in each case, its final purified composition is closely monitored, and, as for effluent discharge processes they are heavily regulated by Federal agencies.

The key goal for a wastewater treatment program is the removal of dissolved and suspended impurities which span the range from angstrom to nanometer to micron sized species, i.e., from dissolved salts to colloids to suspended solids, respectively. The most commonly used process to remove colloids and suspended solids from wastewater sources is to use polymer electrolytes through the actions of coagulation and flocculation. Most colloidal particles have negatively charged surfaces, and, because of this they tend to repel each other and form a stabilized network of dispersed particles. As a consequence of the negatively charged surface, ions in solution stabilize the surface potential through charge paring and an electrical double layer is created. The double layer consists of two major regions, a tightly bound region of ions on the surface named the Stern layer and a more diffuse outer region named the Guoy layer. The electrical double layer generates an even larger radial-barrier that far extends the core colloid particle and prevents particle-particle adhesion. This protective electrical barrier needs to be overcome to facilitate agglomeration, a requirement for improving the settling rates of suspended solids.

Both the particle size and surface charge control the overall stability of a colloidal particle, i.e., the higher the surface charge density the greater the stability. This because the charge density, which is largely dictated by the Stern layer, sets a kinetic energy barrier that must be overcome for agglomeration to occur when two particles collide. The chemicals used in coagulation and flocculation, perturb the potential energy of the colloid's charged double layer, reducing particle-particle repulsions and disrupting the stability of the dispersion. These smaller particles agglomerated, forming a floc, which settles at a faster rate than untreated particles. The two processes of coagulation and flocculation are sometimes confused with each other, in part, because the underlying floc-mechanisms are similar, i.e., bring particles together, but differ only in terms of the size of the floc in question. Coagulation compresses the electrical double layer of a colloid lowering the kinetic energy barrier for agglomeration which brings particles together while flocculation bridges these agglomerates to generate a denser, faster settling, but more porous network.

The most widely used polymer coagulants are alkylammonium salts of tannin derived from a Mannich reaction, and polymers and copolymers of diallyldimethylammonium chloride (DADMAC), derived from epichlorohydrin. The Mannich reaction creates a covalent linkage between an amine, formaldehyde, and an enolizable organic fragment. In the United States, products containing formaldehyde are regulated because formaldehyde is listed as a Group 2A compound on the International Agency for Research on Cancer (IARC) chemical list, which denotes that it is probably carcinogenic to humans. Some European countries have banned the use of materials derived from the Mannich process because the reaction is dynamic and reversible; under certain conditions, a Mannich derived material can be hydrolyzed and leach out formaldehyde into water sources and ultimately into drinking water supplies. Similarly, the presence of residual epichlorohydrin in drinking water applications is highly regulated by the EPA and is restricted to levels below 0.01% of a 20 mg/L of a dosed polymer or chemical. In anticipation of further restricted use of epichlorhydrin and formaldehyde containing materials in other wastewater treatment applications we have become interested in finding alternative “green” materials for wastewater treatment. Therefore, there remains a need for new epichlorohydrin-free and formaldehyde free polymer electrolytes for use in water treatment processes as coagulants.

### BRIEF DESCRIPTION

It has been unexpectedly discovered that a maleic anhydride polymer that has pendant groups that contain at least one quaternary amine group are effective coagulants for use in treating wastewater and other waters containing dispersed impurities. Accordingly, in various aspects, embodiments of the present invention relate to such polymers, methods for using the polymers for water treatment, and processes for preparing the polymers.

### DETAILED DESCRIPTION

Polymers according to embodiments of the present invention are water soluble and have a high positive charge density. They may be prepared from maleic anhydride polymers and copolymers by converting the anhydride group to an aminoamide group, and quaternizing the aminoamide group, as illustrated in Scheme 1.

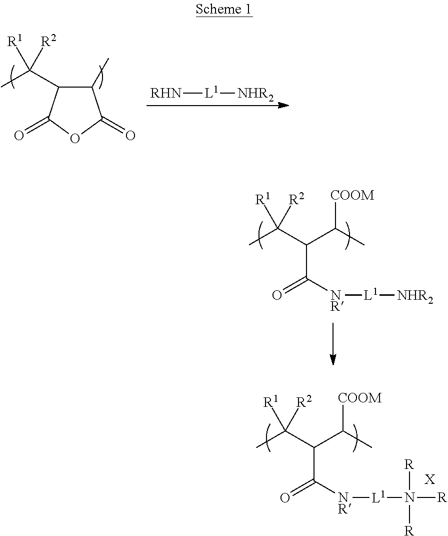

wherein
M is H⁺, NH₄⁺ or an alkali metal cation;
R is independently at each occurrence H, alkyl, substituted alkyl, aryl, or substituted aryl;
R′ is independently at each occurrence H, alkyl, substituted alkyl, aryl, or substituted aryl;
R″ is independently at each occurrence H, alkyl, substituted alkyl, aryl, substituted aryl, or -L²NR₃X;
L¹ and L² are independently at each occurrence alkylene, oxaalkylene, or substituted alkylene; and
X is an anion.

In the first step, anhydride groups react with an alkyl polyamine to form a tertiary aminopolymer. An alkyl polyamine is a branched or linear alkyl compound that includes at least two amino groups; the groups may be primary, secondary or tertiary, and may be located at a terminal position or embedded in the alkyl chain or branch. A tertiary aminopolymer is a polymer having a tertiary amino group located on a side chain or group pendant from the main polymer chain. The alkyl polyamine may be a compound of formula

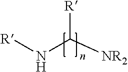

wherein n is 1-10. In particular, the alkyl polyamine may be N, N′-dimethylethylene diamine.

In the second step, the tertiary amino groups are reacted with a quaternizing agent to form quaternary amine groups. In the context of the present invention, a quaternizing agent is a reagent capable of delivering an alkyl group to a tertiary nitrogen atom via nucleophilic attack by the nitrogen on an electrophile or on an electrophilic center of the reagent include alkylating reagents and electrophilic alkyl quaternary ammonium salts. Quaternizing agents are well known to those of skill in the art, and include, but are not limited to, alkyl or alkylaryl halides, tosylates, and methansulfonates and electrophilic alkyl quaternary ammonium salts, such as those described in U.S. Pat. No. 3,636,114, U.S. Pat. No. 4,109,094, WO2011035034, and JOC, 1987, 52, (23), 5247-5254; Polyhedron 2008, 27, (9-10), 2226-2230. Specific examples include, but are not limited to, benzyl chloride and glycidyltrimethylammonium chloride

The pendant groups may contain a single quaternary amine group, or they may contain two or more of the quat groups. A double quaternary ammonium center may minimize the effects of internal charge neutralization at elevated pH when the deprotonated carboxylic acid may function as an internal counter ion for the positively charged quaternary ammonium center. This avoids total neutralization of the cationic charge on the polymer and maintains coagulation efficacy.

The product polymer includes repeat units of formula

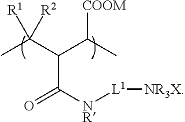

Greater than 50% of the repeat units derived from maleic anhydride may have the pendant group containing at least one quaternary amine group; in particular, greater than 80% of the repeat units may contain that pendant group.

In particular embodiments, the alkyl polyamine is N,N′ dimethylethylene diamine, and the electrophilic alkyl quaternary ammonium salt is glycidyltrimethylammonium chloride and the repeat unit is of formula

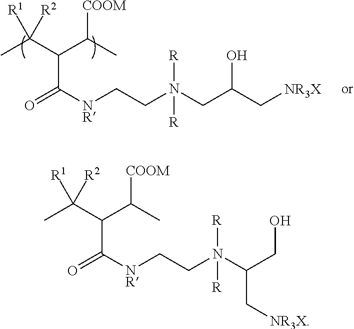

Polymers according to embodiments of the present invention may also include a repeat unit containing a cyclic amide group of formula

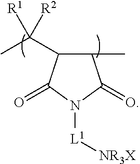

The amide may be formed from the acyclic amide by intramolecular rearrangement.

Maleic anhydride polymers for use as starting materials in preparing polymers according to embodiments of the present invention may include repeat units formed from alpha, beta-α, β-unsaturated monomers that copolymerize readily with maleic anhydride. Non-limiting examples of suitable comonomers include alkylvinylethers such as methylvinylether, ethylvinylether, propylvinylether, alkenes such as ethylene, 1-octadecene, styrene, styrene sulfonic acid, isobutylene, propene, propylene, vinyl acetate and acrylic acid. In many cases, suitable comonomers form alternating copolymers with maleic anhydride, including, for example, methylvinylether and isobutylene. In particular, polymers according to embodiments of the present invention may include repeat units derived from at least one of isobutylene and methylvinyl ether.

Weight average (M_{w}) molecular weight of the polymers is less than 1,000,000 Daltons, and may range from about 5000 Daltons to less than 1,000,000 Daltons, particularly from about 5000 Daltons to about 200,000 Daltons. In some embodiments, molecular weight ranges from about 5000 to about 100,000. The polymer should be large enough to generate a coagulant floc but not large to form a bridge between flocs.

Water containing suspended particles and other aqueous suspensions of particulate material may be treated by the methods of the present invention. Such water may have its origin either in natural or artificial sources, including industrial and sanitary sources. Waters containing suspended particles of natural origin are usually surface waters, in which the particles are suspended soil particles (silt), although sub-surface waters may also be treated. Water having its origin in industrial processes (including sanitary water) may contain many different varieties of suspended particles which are generally the result of the particular industrial or sanitary operation undertaken. Prior to discharging such industrial waters into natural water courses it is usually necessary that the suspended matter be removed. Methods according to embodiments of the present invention may likewise be applied to water contained in stock or fish ponds, lakes or other natural or artificial bodies of water containing suspended solids, to industrial water supplied either in preparation therefor, during or after use and prior to disposal, to sanitary water supplies either for the elimination of suspended solids prior to use for such purposes, or to waters which have become contaminated with impurities from any source.

Polymers according to embodiments of the present invention typically cause rapid coagulation and also reinforce formed aggregates of particles causing a general tightening or bonding together of the initial particles and an increased rate of coagulation and settling, thus forming a less turbid supernatant liquid.

The addition of the polymers according to embodiments of the present invention to aqueous suspensions may be done so that the resulting coagulation and aggregation of particles takes place uniformly throughout the body of the water. In order to add the polymers to the water-borne suspension uniformly, a relatively dilute stock solution may be added to the water.

The amount of the polymers according to embodiments of the present invention used may vary depending upon the amount and the degree of subdivision of the solids to be agglomerated or flocculated, and the chemical nature of such solids. In general, not more than 1000 ppm by weight of suspended solids, but at least a sufficient amount to promote coagulation are used; typically at least 1 ppm is used. A sufficient amount of the polymers according to embodiments of the present invention should be used to ensure that coagulation takes place without causing the formation of stable dispersions, i.e., a concentration in the treated water of not more than 0.1%/by weight, based upon the solids present.

### Definitions

As used herein, the term “about” means within 10% of a given value, particularly within 5%, and more particularly within 1% of a given value. Alternatively, the term “about” means that a value can fall within a scientifically acceptable error range for that type of value, which will depend on how qualitative a measurement can be given the available tools.

In the context of the present invention, alkyl is intended to include linear, branched, or cyclic hydrocarbon structures and combinations thereof, including lower alkyl and higher alkyl. More particularly, alkyl groups are those of C₂₀ or below. Lower alkyl refers to alkyl groups of from 1 to 6 carbon atoms, more particularly from 1 to 4 carbon atoms, and includes methyl, ethyl, n-propyl, isopropyl, and n-, s- and t-butyl. Higher alkyl refers to alkyl groups having seven or more carbon atoms, more particularly 7-20 carbon atoms, and includes n-, s- and t-heptyl, octyl, and dodecyl. Cycloalkyl is a subset of alkyl and includes cyclic hydrocarbon groups of from 3 to 8 carbon atoms. Examples of cycloalkyl groups include cyclopropyl, cyclobutyl, cyclopentyl, cyclohexyl, and norbornyl. Alkenyl and alkynyl refer to alkyl groups wherein two or more hydrogen atoms are replaced by a double or triple bond, respectively.

Aryl and heteroaryl mean a 5- or 6-membered aromatic or heteroaromatic ring containing 0-3 heteroatoms selected from nitrogen, oxygen or sulfur; a bicyclic 9- or 10-membered aromatic or heteroaromatic ring system containing 0-3 heteroatoms selected from nitrogen, oxygen or sulfur; or a tricyclic 13- or 14-membered aromatic or heteroaromatic ring system containing 0-3 heteroatoms selected from nitrogen, oxygen or sulfur. The aromatic 6- to 14-membered carbocyclic rings include, for example, benzene, naphthalene, indane, tetralin, and fluorene; and the 5- to 10-membered aromatic heterocyclic rings include, e.g., imidazole, pyridine, indole, thiophene, benzopyranone, thiazole, furan, benzimidazole, quinoline, isoquinoline, quinoxaline, pyrimidine, pyrazine, tetrazole and pyrazole.

Arylalkyl means an alkyl residue attached to an aryl ring. Examples are benzyl and phenethyl. Heteroarylalkyl means an alkyl residue attached to a heteroaryl ring. Examples include pyridinylmethyl and pyrimidinylethyl. Alkylaryl means an aryl residue having one or more alkyl groups attached thereto. Examples are tolyl and mesityl.

Alkoxy or alkoxyl refers to groups of from 1 to 8 carbon atoms of a straight, branched, cyclic configuration and combinations thereof attached to the parent structure through an oxygen. Examples include methoxy, ethoxy, propoxy, isopropoxy, cyclopropyloxy, and cyclohexyloxy. Lower alkoxy refers to groups containing one to four carbons.

Acyl refers to groups of from 1 to 8 carbon atoms of a straight, branched, cyclic configuration, saturated, unsaturated and aromatic and combinations thereof, attached to the parent structure through a carbonyl functionality. One or more carbons in the acyl residue may be replaced by nitrogen, oxygen or sulfur as long as the point of attachment to the parent remains at the carbonyl. Examples include acetyl, benzoyl, propionyl, isobutyryl, t-butoxycarbonyl, and benzyloxycarbonyl. Lower-acyl refers to groups containing one to four carbons.

Heterocycle means a cycloalkyl or aryl residue in which one or two of the carbon atoms is replaced by a heteroatom such as oxygen, nitrogen or sulfur. Examples of heterocycles that fall within the scope of the embodiments of the present invention include pyrrolidine, pyrazole, pyrrole, indole, quinoline, isoquinoline, tetrahydroisoquinoline, benzofuran, benzodioxan, benzodioxole (commonly referred to as methylenedioxyphenyl, when occurring as a substituent), tetrazole, morpholine, thiazole, pyridine, pyridazine, pyrimidine, thiophene, furan, oxazole, oxazoline, isoxazole, dioxane, and tetrahydrofuran.

Substituted refers to residues, including, but not limited to, alkyl, alkylaryl, aryl, arylalkyl, and heteroaryl, wherein up to three H atoms of the residue are replaced with lower alkyl, substituted alkyl, alkenyl, substituted alkenyl, aryl, substituted aryl, haloalkyl, alkoxy, carbonyl, carboxy, carboxalkoxy, carboxamido, acyloxy, amidino, nitro, halo, hydroxy, OCH(COOH)₂, cyano, primary amino, secondary amino, acylamino, alkylthio, sulfoxide, sulfone, phenyl, benzyl, phenoxy, benzyloxy, heteroaryl, or heteroaryloxy.

Haloalkyl refers to an alkyl residue, wherein one or more H atoms are replaced by halogen atoms; the term haloalkyl includes perhaloalkyl. Examples of haloalkyl groups that fall within the scope of the embodiments of the present invention include CH₂F, CHF₂, and CF₃.

Oxaalkyl refers to an alkyl residue in which one or more carbons have been replaced by oxygen. It is attached to the parent structure through an alkyl residue. Examples include methoxypropoxy, 3,6,9-trioxadecyl and the like. The term oxaalkyl refers to compounds in which the oxygen is bonded via a single bond to its adjacent atoms, forming ether bonds; it does not refer to doubly bonded oxygen, as in carbonyl groups. Similarly, thiaalkyl and azaalkyl refer to alkyl residues in which one or more carbons has been replaced by sulfur or nitrogen, respectively. Examples include ethylaminoethyl and methylthiopropyl.

### EXAMPLES

### Materials and Methods

All solvents were used as is and were dried prior to use when necessary according to literature procedures. Absolute and 95% Ethanol (Phamco) were used as received. All other reagents and starting materials were purchased from Aldrich, VWR, Acros, Strem, Fluka, or Alpha Aesar and used without further purification. IR spectra were collected on solid samples using a PerkinElmer Spectrum 100 FT-IR spectrometer with a universal ATR (attenuated total reflectance) sampler.

### Example 1

### Synthesis of Benzyl Quaternary Ammonium Salt of poly (MVE-alt-MA) (MVEMAQ)

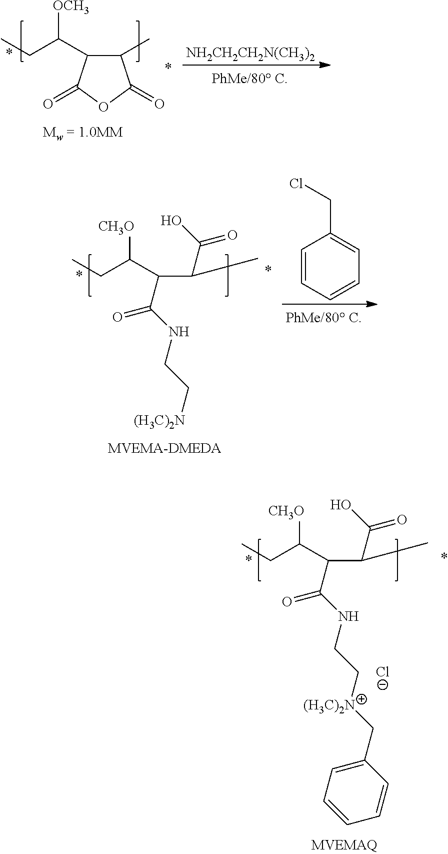

A kettle reactor equipped with a condenser, an addition funnel, a thermocouple, and an overhead stirrer with a particle de-sizing blade was charged with poly (MVE-alt-MA) (20 g, 80.44 mmol of MA, Mw=1.08×106). The polymer was suspended in toluene (300 mL) and DMEDA (8.5 g, 96.5 mmol) was added dropwise and the mixture rapidly stirred and heated at 80° C. for 15 hrs. Benzyl chloride (22.4 g, 180 mmol) was added and the mixture was heated at 80° C. for 2 hrs. The mixture was cooled to 35° C. and was diluted with hexanes (500 mL) while mixing and the precipitated solid was collected by filtration in a dry nitrogen purge box, washed with hexanes and then dried in a vacuum oven at 40° C. overnight to give a green-blue solid. Product contained residual amount of toluene. Yield 37.2 g. Theoretical 37.2 g.

### Example 2

### Synthesis of Benzyl Quaternary Ammonium Salt of poly (IB-alt-MA) (IBMAQ)

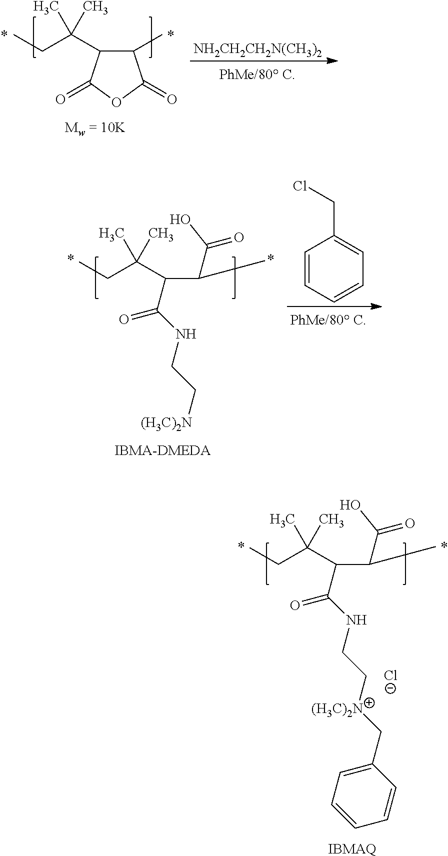

The same procedure as described for MVEMAQ was used to prepare IBMAQ. Poly (IB-alt-MA) (20 g, 82.4 mmol of MA, Mw=10K), DMEDA (8.7 g, 98.9 mmol), Benzyl chloride (22.9 g, 181 mmol). was added and the mixture was heated at 80° C. for 2 hrs. The precipitated solid was collected by filtration in a dry nitrogen purge box, washed with hexanes and then dried in a vacuum oven at 40° C. overnight to give a light yellow solid. Product contained residual amount of toluene. Yield: 39.0 g. Theoretical yield: 37.7 g.

### Example 3

### Synthesis of Glycidyl Quaternary Ammonium Salt of poly (IB-alt-MA) (IBMAQQ)

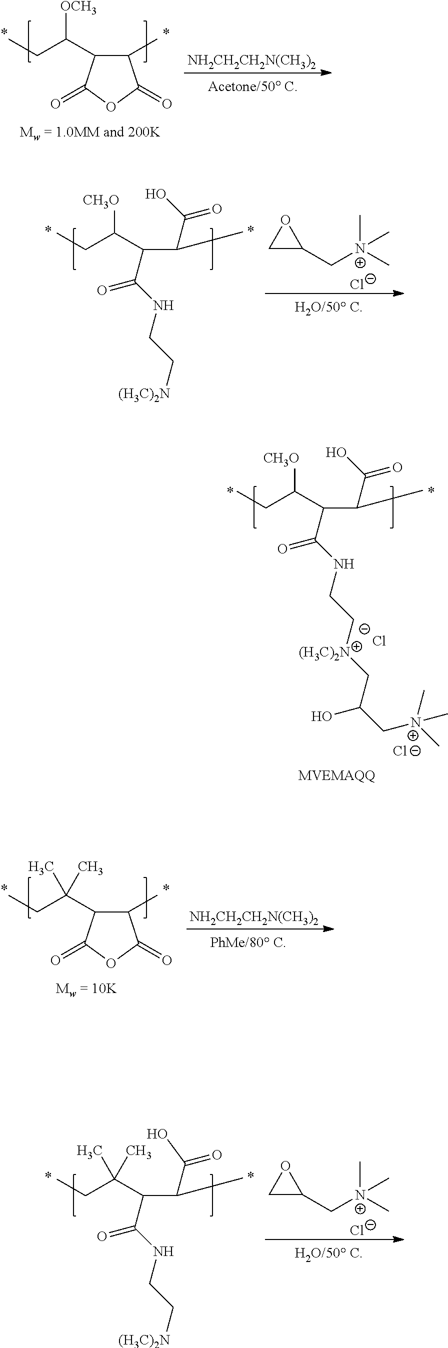

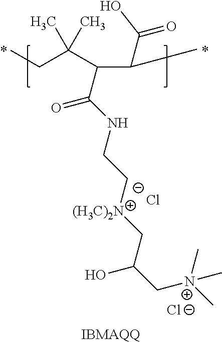

A kettle reactor equipped with a condenser, an addition funnel, a thermocouple, and an overhead stirrer with a particle de-sizing blade was charged with poly (IB-alt-MA) (20 g, 82.4 mmol of MA, Mw=10K). The polymer was suspended in acetone (500 mL) and DMEDA (8.5 g, 96.5 mmol) was added dropwise and the mixture rapidly stirred and heated at 80° C. for 4 hrs. An aliquot was removed and was sampled by ATR-IR spectroscopy which revealed no change in the IBMA spectrum. The acetone was removed by distillation and replaced with toluene (350 mL) and the mixture was heated at 80° C. for 11 hrs. The solvents were removed to near dryness and the residue was triturated with acetone/hexanes (1:1) to give a tarry solid which was broken down onto smaller pieces by stirring at high speed with 100% hexanes. The solid was collected by filtration in a nitrogen purge box, washed with hexanes and dried. The solid was then dissolved in H2O (250 mL) and treated with glycidyltrimethylammonium chloride (18 mL) with heating at 50° C. for 15 hrs. The mixture was cooled and the solvents were removed by adding MeOH and concentration by evaporation on a rotary evaporator. The final tarry solid was dissolved in MeOH (150 mL) and added to ethyl ether (1000 mL) to precipitate the polymer product. The precipitated solid was collected by filtration in a dry nitrogen purge box, washed with ethyl ether and then dried in a vacuum oven at 40° C. overnight to give a light yellow colored solid. Yield 27.2 g. Theoretical 39.7 g.

### Example 4

### Synthesis of Glycidyl Quaternary Ammonium Salt of poly (MVE-alt-MA) (MVEMAQQ-200K)

A kettle reactor equipped with a condenser, an addition funnel, a thermocouple, and an overhead stirrer with a particle de-sizing blade was charged with poly (MV-alt-MA) (20 g, 80.44 mmol of MA, Mw=200K). The polymer was dissolved in acetone (300 mL) and DMEDA (18.0 mL, 14.5 g, 164 mmol) was added dropwise and the mixture rapidly stirred at RT overnight and then heated at 50° C. for 5 hrs. The intermediate was precipitated by adding hexanes and collected by filtration in a nitrogen purge box and dried. The solid material was pulverized with a mortar and pestle and dried in a vacuum oven at 40° C. overnight (30.8 g). The IR spectrum of the dried product looks consistent with DMEDA adduct. An aliquot was removed and was sampled by ATR-IR spectroscopy which revealed no change in the IBMA spectrum. The solid was then dissolved in H2O (250 mL) and treated with glycidyltrimethylammonium chloride (18 mL) with heating at 50° C. for 15 hrs. The mixture was cooled and the solvents were removed by adding MeOH and concentration by evaporation on a rotary evaporator. The final tarry solid was dissolved in MeOH (150 mL) and added to ethyl ether (1000 mL) to precipitate the polymer product. The precipitated solid was collected by filtration in a dry nitrogen purge box, washed with ethyl ether and then dried in a vacuum oven at 40° C. overnight to give a blue/green colored solid. Isolated yield 29.9 g. Theoretical yield: 37.3 g.

### Example 5

### Synthesis of Glycidyl Quaternary Ammonium Salt of poly (MVE-alt-MA) (MVEMAQQ-1.0MM)

A kettle reactor equipped with a condenser, an addition funnel, a thermocouple, and an overhead stirrer with a particle de-sizing blade was charged with poly (MV-alt-MA) (20 g, 80.44 mmol of MA, Mw=1.08MM). The polymer was dissolved in acetone (400 mL) and DMEDA (18.0 mL, 14.5 g, 164 mmol) was added dropwise and the mixture rapidly stirred and heated at 50° C. for 5 hrs. The intermediate was precipitated by adding hexanes and collected by filtration in a nitrogen purge box and dried. The solid material was pulverized with a mortar and pestle and dried in a vacuum oven at 40° C. overnight. The solid was then dissolved in H2O (250 mL) and treated with glycidyltrimethylammonium chloride (18 mL) by stirring at RT for 15 hrs and then with heating at 50° C. for 15 hrs. The mixture was concentrated to approximately to 100 mL and prepcipitted by pouring this solution into EtOH (500 mL). The solvents were decanted and then the solids were washed with Acetone/EtOH (1:1) under rapid stirring. The solvents were decanted and the solid was washed with a mixture of Acetone/Hexanes (1:1) with rapid stirring. The solids were collected by filtration in a dry nitrogen purge box, washed with Hexanes and then dried in a vacuum oven at 40° C. overnight to give a light yellow colored solid. Isolated yield 29.6 g. Theoretical yield: 37.3 g.

### Example 6

Performance of the quaternary ammonium salts at settling solids in a standard jar test was compared to the commercial polycationic product PC 1192. Coagulation performance was evaluated by measuring the final turbidity of the supernatant phase of synthetic river water clay after settling over a range of doses. The double quaternary ammonium materials performed better than the single quaternary ammonium salts for the MVEMA and IBMA polycations.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A polymer comprising repeat units derived from maleic anhydride, a plurality of the repeat units having a pendant group comprising at least one quaternary amine group.

2. A polymer according to claim 1, additionally comprising repeat units derived from at least one of isobutylene and an alkylvinyl ether.

3. A polymer according to claim 1, wherein the pendant group is of formula 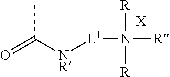
wherein
R is independently at each occurrence H, alkyl, substituted alkyl, aryl, or substituted aryl;
R′ is independently at each occurrence H, alkyl, substituted alkyl, aryl, or substituted aryl;
R″ is independently at each occurrence H, alkyl, substituted alkyl, aryl, substituted aryl, or -L²NR₃X;
L¹ and L² are independently at each occurrence alkylene, oxaalkylene, or substituted alkylene; and
X is an anion.

4. A polymer according to claim 1, additionally comprising repeat units of formula 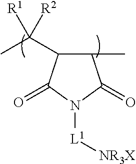
wherein
R is independently at each occurrence H, alkyl, substituted alkyl, aryl, or substituted aryl;
R′ is independently at each occurrence H, alkyl, substituted alkyl, aryl, or substituted aryl;
R″ is independently at each occurrence H, alkyl, substituted alkyl, aryl, substituted aryl, or -L²NR₃X;
L¹ and L² are independently at each occurrence alkylene, oxaalkylene, or substituted alkylene; and
X is an anion.

5. A polymer according to claim 1, wherein the pendant group is of formula 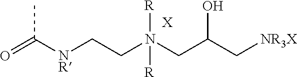
wherein
R is independently at each occurrence H, alkyl, substituted alkyl, aryl, or substituted aryl;
R′ is independently at each occurrence H, alkyl, substituted alkyl, aryl, or substituted aryl; and
X is an anion.

6. A polymer according to claim 1, additionally comprising repeat units derived from isobutylene.

7. A polymer according to claim 1, additionally comprising repeat units derived from methylvinyl ether.

8. A polymer according to claim 1, comprising repeat units of formula 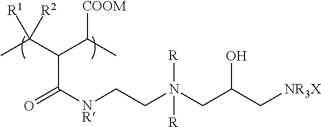
wherein
M is H⁺, NH₄⁺ or an alkali metal cation;
R is independently at each occurrence H, alkyl, substituted alkyl, aryl, or substituted aryl;
R′ is independently at each occurrence H, alkyl, substituted alkyl, aryl, or substituted aryl;
X is an anion;
R¹ is H or methyl;
R² is methyl or C₁-C₃ alkoxy; and
for each repeat unit, when R¹ is H, R² is C₁-C₃ alkoxy, and when R¹ is methyl, R² is methyl.

9. A method for treating water containing dispersed impurities, the method comprising contacting the water with a polymer according to claim 1.

10. A method for treating water containing dispersed impurities, the method comprising contacting the water with a coagulant comprising a polymer having repeat units derived from maleic anhydride, the repeat units having pendant groups comprising at least one quaternary amine group;
whereby the dispersed impurities are at least partially removed from the water.

11. A method according to claim 10, wherein the pendant group is of formula 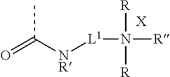
wherein
R is independently at each occurrence H, alkyl, substituted alkyl, aryl, or substituted aryl;
R′ is independently at each occurrence H, alkyl, substituted alkyl, aryl, or substituted aryl;
R″ is independently at each occurrence H, alkyl, substituted alkyl, aryl, substituted aryl, or -L²NR₃X;
L¹ and L² are independently at each occurrence alkylene, oxaalkylene, or substituted alkylene; and
X is an anion.

12. A method according to claim 10, wherein the pendant group is of formula 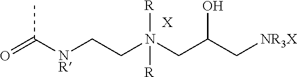
wherein
R is independently at each occurrence H, alkyl, substituted alkyl, aryl, or substituted aryl;
R′ is independently at each occurrence H, alkyl, substituted alkyl, aryl, or substituted aryl; and
X is an anion.

13. A method according to claim 10, wherein the polymer additionally comprises repeat units derived from at least one of isobutylene and an alkylvinyl ether.

14. A method according to claim 10, wherein the polymer additionally comprises repeat units derived from isobutylene.

15. A method according to claim 10, wherein the polymer additionally comprises repeat units derived from methylvinyl ether.

16. A method according to claim 10, wherein the polymer coagulant comprises repeat units of formula 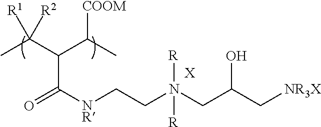
wherein
R is independently at each occurrence H, alkyl, substituted alkyl, aryl, or substituted aryl;
X is an anion;
R¹ is H or methyl;
R² is methyl or C₁-C₃ alkoxy; and
for each repeat unit, when R¹ is H, R² is C₁-C₃ alkoxy, and when R¹ is methyl, R² is methyl.

17. A method according to claim 10, wherein greater than 50% of the repeat units derived from maleic anhydride have the pendant group comprising at least one quaternary amine group.

18. A method according to claim 10, wherein greater than 80% of the repeat units derived from maleic anhydride have the pendant group comprising at least one quaternary amine group.

19. A method according to claim 10, wherein molecular weight of the polymer ranges from about 5000 Daltons to less than 1,000,000 Daltons.

20. A method according to claim 10, wherein molecular weight of the polymer ranges from about 5000 Daltons to about 200,000 Daltons.

21. A method for preparing a polymer having repeat units derived from maleic anhydride, a plurality of the repeat units having a pendant group comprising at least one quaternary amine group, the method comprising reacting a quaternizing agent or an electrophilic alkyl quaternary ammonium salt with a tertiary aminopolymer having repeat units derived from maleic anhydride, each repeat unit having a pendant group comprising at least one tertiary amine group.

22. A method according to claim 21, wherein the electrophilic alkyl quaternary ammonium salt is an epoxy alkyl quaternary ammonium salt.

23. A method according to claim 21, wherein the electrophilic alkyl quaternary ammonium salt is glycidyltrimethylammonium chloride.

24. A method according to claim 21, additionally comprising forming the tertiary aminopolymer by reacting an alkyl polyamine with anhydride groups of an anhydride-functional polymer comprising repeat units derived from maleic anhydride.

25. A method according to claim 24, wherein the alkyl polyamine is of formula 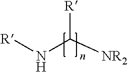
wherein
R is independently at each occurrence H, alkyl, substituted alkyl, aryl, or substituted aryl;
R′ is independently at each occurrence H, alkyl, substituted alkyl, aryl, or substituted aryl; and
n is 1-10.

26. A method according to claim 24, wherein the alkyl polyamine is N,N′-dimethylethylene diamine.

27. A method according to claim 21, wherein the repeat units are of formula 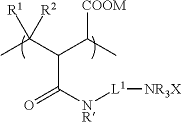
wherein
M is H⁺, NH₄⁺ or an alkali metal cation;
R is independently at each occurrence H, alkyl, substituted alkyl, aryl, or substituted aryl;
R′ is independently at each occurrence H, alkyl, substituted alkyl, aryl, or substituted aryl;
L¹ and L² are independently at each occurrence alkylene, oxaalkylene, or substituted alkylene;
X is an anion;
R¹ is H or methyl;
R² is methyl or C₁-C₃ alkoxy; and
for each repeat unit, when R¹ is H, R² is C₁-C₃ alkoxy, and when R¹ is methyl, R² is methyl.

28. A method according to claim 21, wherein greater than 50% of the repeat units derived from maleic anhydride have the pendant group comprising at least one quaternary amine group.

29. A method according to claim 21, wherein greater than 80% of the repeat units derived from maleic anhydride have the pendant group comprising at least one quaternary amine group.

30. A method according to claim 21, wherein the repeat units are of formula [chemical structure]
